(19) United States
(12) Patent Application Publication
(10) Pub. No.: US 2002/0147806 A1
(43) Pub. Date: Oct. 10, 2002

(54) Remote maintenance system and data processing system using electronic mail

(75) Inventor: Kiyoshi Hasegawa, Tokyo (JP)

Correspondence Address: ARMSTRONG,WESTERMAN & HATTORI, LLP, 1725 K STREET, NW., SUITE 1000, WASHINGTON, DC, 20006, US

(73) Assignee: Yokogawa Electric Corporation, Musashino-shi (JP)

(21) Appl. No.: 10/112,702

(22) Filed: Apr. 2, 2002

(30) Foreign Application Priority Data
Apr. 6, 2001 (JP) 2001-108441
Sep. 27, 2001 (JP) 2001-296444

(51) Int. Cl. G06F 15/173

(52) U.S. Cl. 709/223

(57) ABSTRACT

The present invention provides a remote maintenance system that eliminates the need for reconfiguring the network environment.

In addition, the present invention is intended to solve the problem that the response of equipment becomes slower due to a delay in the timing for receiving emails when they arrive at higher frequencies since the interval of checking for arrival of any email addressed to the equipment itself is relatively long.

The remote maintenance system for remotely configuring and maintaining target equipment comprises the target equipment to be remotely maintained and a command unit for sending emails containing commands to the target equipment through the Internet, wherein the target equipment executes a command contained in an email, so that the target equipment is configured and maintained.

The remote maintenance system is designed so that when an email addressed to the target equipment arrives, the interval of checking for incoming emails is automatically shortened for a given period of time. In addition, if another email has arrived when the checking for incoming emails is performed at the shorter interval, the above-mentioned period of time is prolonged. As a result, it is possible to speed up the response of the target equipment and avoid imposing excess load on the mail server, or the like.

### BACKGROUND OF THE INVENTION

1. Field of Invention

The present invention relates to a remote maintenance system for remotely configuring and maintaining control equipment, such as controllers, and more particularly, to a remote maintenance system that eliminates the need for reconfiguring the network environment.

In addition, the present invention relates to a data processing system based on electronic mail, and more particularly, to an electronic mail based data processing system that may be preferably used for remote maintenance or monitoring systems.

2. Description of the Prior Art

In a conventional remote maintenance system, required tasks include reading/writing data from/to a controller, reading, writing and modifying programs stored in the controller, reading log information from the controller, and setting various data items and an operation mode on the controller through a local area network (LAN).

FIG. 1 is a schematic view showing an example of the way such a conventional remote maintenance system as mentioned above is configured. In FIG. 1, numerals 1 and 4 denote general-purpose computers, such as personal computers (hereinafter simply referred to as computers), numeral 2 denotes a controller, which is the equipment to be maintained, numeral 3 denotes a firewall, numeral 5 denotes a cellular phone that can communicate through the Internet, numeral 100 denotes a LAN, and numeral 200 denotes the Internet.

The computer 1 is connected to the controller 2 through the LAN 100. The LAN 100 is connected through the firewall 3 to the Internet 200, to which the computer 4 and cellular phone 5 are connected.

Now, the behavior of the example of the conventional remote maintenance system is described by referring to FIGS. 2 and 3. FIG. 2 is a table showing protocols, etc. that are used by the Internet and controller 2 compatible with the structural model of the seven-layer network protocol established by the International Organization for Standardization (ISO), and FIG. 3 is a schematic view explaining communication carried out between the computer 1 and controller 2.

When the controller 2 is remotely maintained through the LAN 100 from the computer 1, the computer 1 sends commands in ASCII (American Standard Code for Information Interchange) or binary code to the controller 2, by using the Transmission Control Protocol (TCP) or User Datagram Protocol (UDP) of the transport layer shown in FIG. 2.

For example, the computer 1 sends a command to the controller 2 by using TCP or UDP, as indicated by “RC01”in FIG. 3.

On the other hand, the controller 2 that has received a command from the LAN 100 executes the command and sends a response to the computer 1 in ASCII or binary code, as necessary, by using TCP or UDP of the transport layer shown in FIG. 2.

For example, the controller 2 sends a response to the computer 1 by using TCP or UDP, as indicated by “RS01” in FIG. 3.

Now, the behavior of the controller 2 is explained in detail by referring to FIGS. 4 and 5. FIG. 4 is a block diagram showing an example of the way the controller 2 is configured, and FIG. 5 is a block diagram showing in detail the way the control unit of the controller 2 is configured.

In FIG. 4, numeral 100 denotes the same element as in FIG. 1, numeral 6 denotes a control unit that controls the controller 2 as a whole, numeral 7 denotes an I/O unit to which various inputs and outputs are connected, numeral 8 denotes a memory unit in which data, programs wherein the way the controller 2 is operated is written, and so on are stored, and numeral 9 denotes a communication unit that communicates through the LAN 100.

The LAN 100 is connected to the communication unit 9, the input and output of which and those of the control unit 6 are mutually connected to each other. Likewise, the input and output of the I/O unit 7 and those of the memory unit 8 are mutually connected to each other.

In FIG. 5, numeral 10 denotes a control function, and numeral 11 denotes a communications processing function compatible with the TCP or UDP communication protocol, wherein data received from the communication unit 9 is processed by the communications processing function 11 and the result of processing is passed to the control function 10.

The communication unit 9 receives a command arriving through the LAN 100, and the control unit 6 receives the command from the communication unit 9 and executes it. For example, if the command is a request to read data from the controller 2, then the control unit 6 reads the specified data stored in the memory unit 8 and sends it to the LAN 100 through the communication unit 9.

At this point, the communications processing function 11 transfers the ASCII- or binary-coded command it received through the communication unit 9 according to TCP or UDP, to the control function 10.

The control function 10 then executes the command and transfers a response to the communications processing function 11, as necessary.

The communications processing function 11 that has received the response from the control function 10 sends out the response through the communication unit 9 according to TCP or UDP.

As a result, it is possible for the computer 1 to maintain the controller 2 through the LAN 100, by sending a command to the controller 2 by means of TCP or UDP and allowing the controller 2 to execute the received command.

By sending a response from the controller 2 as necessary using TCP or UDP, it is also possible to obtain necessary data or verify the controller' configuration and operating condition on the computer 1 side.

However, when maintenance is attempted from the computer 4 or cellular phone 5 through the Internet 200 to the controller 2 located behind the firewall 3, any command is blocked by the firewall 3 for reasons of the typical configuration thereof, and thus fails to reach the controller 2, since the example of the conventional remote maintenance system shown in FIG. 1 uses TCP or UDP as the communication protocol.

In other words, the conventional remote maintenance system has the problem that the typical configuration of the firewall 3 prevents maintenance from being performed on the controller 2 located internal to the firewall 3 through the Internet 200.

As a result, the firewall 3 must be reconfigured so that a command that uses the TCP or UDP communication protocol can pass through the firewall 3. Since only specific persons, such as a network administrator, are allowed to reconfigure the firewall 3, this reconfiguration is not an easy task. In addition, reconfiguring the firewall 3 is cumbersome and can result in a problem of vulnerability.

An object of the present invention is therefore to provide a remote maintenance system that eliminates the need for reconfiguring the network environment.

As a reference to prior art, the U.S. Pat. U.S. Pat. No. 6,282,454 “Web Interface to a Programmable Controller” may be cited as an example.

This reference presents an example wherein a personal computer has access to a PLC through the Internet. The example introduces a system wherein a Web module, i.e., Web server function, is located on the PLC side, in order to send back a response from the Web module side to a request from the application software side having a browser or browser function. In this case, the Web module and application software having a browser or browser function use Hypertext Transport Protocol (HTTP) as the protocol for handling commands and responses.

In such an example as discussed above, a global IP address must be set to be able to gain access to the Web module through the Internet. Furthermore, in order to be able to monitor equipment information on the PLC side through the browser using that type of Web module, a hypertext document for monitoring desired equipment must be previously made available, and then stored and set within the Web module. Thus, the prior art example has the problem that such a Web module as mentioned above does not permit the monitored equipment to be easily changed.

### SUMMARY OF THE INVENTION

In order to achieve the aforementioned object, the present invention provides a remote maintenance system for remotely configuring and maintaining target equipment, comprising the target equipment to be remotely maintained and a command unit for sending electronic mails (emails) containing commands through the Internet to the target equipment, wherein the need for reconfiguring the network environment is eliminated by allowing the target equipment to execute a command contained in an email that the equipment received, so that the equipment is configured and maintained.

By allowing the target equipment to send an email containing a response to the command unit through the Internet as necessary, it is also possible to obtain required data or verify the equipment' configuration and operating condition on the command unit side.

By writing the command into the text or attached file of the email, it is possible to eliminate the need for reconfiguring the network environment.

By writing the response into the text or the attached file of the email, it is also possible to obtain required data or verify the equipment' configuration and operating condition on the command unit side.

By writing a password into the text or the attached file of the email, it is possible to improve security.

By encrypting and then sending the text or attached file of the email, it is also possible to improve security.

By writing a plurality of commands, instead of the single command, into the text or attached file of the email, it is possible to have a complex process executed with just one email.

By using a controller capable of sending and receiving emails as the target equipment, it is possible to eliminate the need for reconfiguring the network environment. It is also possible to obtain required data or verify the controller' configuration and operating condition on the command unit side.

By using a measuring instrument capable of sending and receiving emails as the target equipment, it is possible to eliminate the need for reconfiguring the network environment. It is also possible to obtain required data or verify the instrument' configuration and operating condition on the command unit side.

By using a recorder capable of sending and receiving emails as the target equipment, it is possible to eliminate the need for reconfiguring the network environment. It is also possible to obtain required data or verify the recorder' configuration and operating condition on the command unit side.

By using office automation equipment capable of sending and receiving emails as the target equipment, it is possible to eliminate the need for reconfiguring the network environment. It is also possible to obtain required data or verify the equipment' configuration and operating condition on the command unit side.

By using control equipment capable of sending and receiving emails as the target equipment, it is possible to eliminate the need for reconfiguring the network environment. It is also possible to obtain required data or verify the equipment' configuration and operating condition on the command unit side.

By using a computer capable of sending and receiving emails as the command unit, it is possible to eliminate the need for reconfiguring the network environment.

By using a cellular phone capable of sending and receiving emails as the command unit, it is also possible to eliminate the need for reconfiguring the network environment.

By using a PHS phone capable of sending and receiving emails as the command unit, it is also possible to eliminate the need for reconfiguring the network environment.

By using a PDA capable of sending and receiving emails as the command unit, it is also possible to eliminate the need for reconfiguring the network environment.

Furthermore, the present invention also provides an email-based data processing system comprising a data processing unit and a mail server connected to the data processing unit, wherein the data processing unit checks for incoming emails at a specified interval by querying the mail server for arrival of any email addressed to the unit itself, in order to receive the email addressed to the unit itself.

The data processing unit is designed so that once the unit confirms the arrival of any email addressed to the unit itself, the interval of checking the mail server for incoming emails is changed, for a given period, to a first interval shorter than the specified interval. This design allows the data processing unit to increase efficiency without imposing excess load on the mail server.

The data processing unit is also designed so that if it detects the arrival of any email addressed to the unit itself while checking the mail server for incoming emails at the first interval, the period during which incoming emails are checked for at the first interval is prolonged for a given period. This design prevents degradation of the response of the data processing unit even when emails arrive at higher frequencies.

A characteristic of the data processing system is that the data processing unit can be a controller for controlling a process or the like. This characteristic permits easy remote maintenance.

Another characteristic of the data processing system is that the controller is capable of at least one function among writing and reading data using emails, reading, writing and modifying programs, reading logging information, and changing various data items and the operating mode. This characteristic permits, for example, controller maintenance using emails.

Another characteristic of the data processing system is that the data processing unit can be a monitoring system. This characteristic prevents degradation of the response of the system even when queries increase at the time of failure.

Another characteristic of the data processing system is that the mail server is connected to the Internet. This characteristic permits access from remote locations.

Another characteristic of the data processing system is that a firewall is located between the mail server and the Internet. This characteristic prevents unauthorized access.

Another characteristic of the data processing system is that emails are sent to the mail server from a cellular phone or PHS phone connected to the Internet. This characteristic permits access to the data processing unit from any location.

### BRIEF DESCRIPTION OF THE DRAWINGS

FIG. 1 is a schematic view showing an example of the way a conventional remote maintenance system is configured.

FIG. 2 is a table showing protocols, etc. that are used by the Internet and controller.

FIG. 3 is a schematic view explaining communication carried out between a computer and a controller.

FIG. 4 is a block diagram showing an example of the way the controller is configured.

FIG. 5 is a block diagram showing in detail the way the control unit of the controller is configured.

FIG. 6 is a schematic view showing one embodiment of the remote maintenance system according to the present invention.

FIG. 7 is a table showing protocols, etc. that are used by the Internet and controller.

FIG. 8 is a schematic view explaining communication carried out between a computer and a controller.

FIG. 9 is a block diagram showing an example of the way the controller is configured.

FIG. 10 is a flowchart explaining the way the control unit of the controller behaves.

FIG. 11 is a block diagram showing in detail the way the control unit of the controller is configured.

FIG. 12 is a schematic view showing the way the remote maintenance system is configured.

FIG. 13 is a schematic view showing the frequency at which incoming emails are checked for.

FIG. 14 is a schematic view showing one embodiment of the present invention.

FIG. 15 is a schematic view showing another embodiment of the present invention.

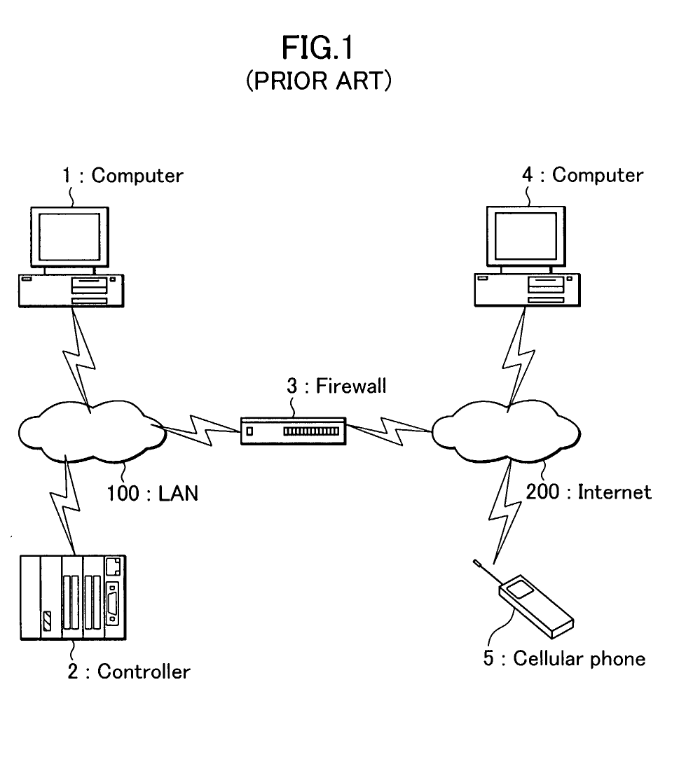

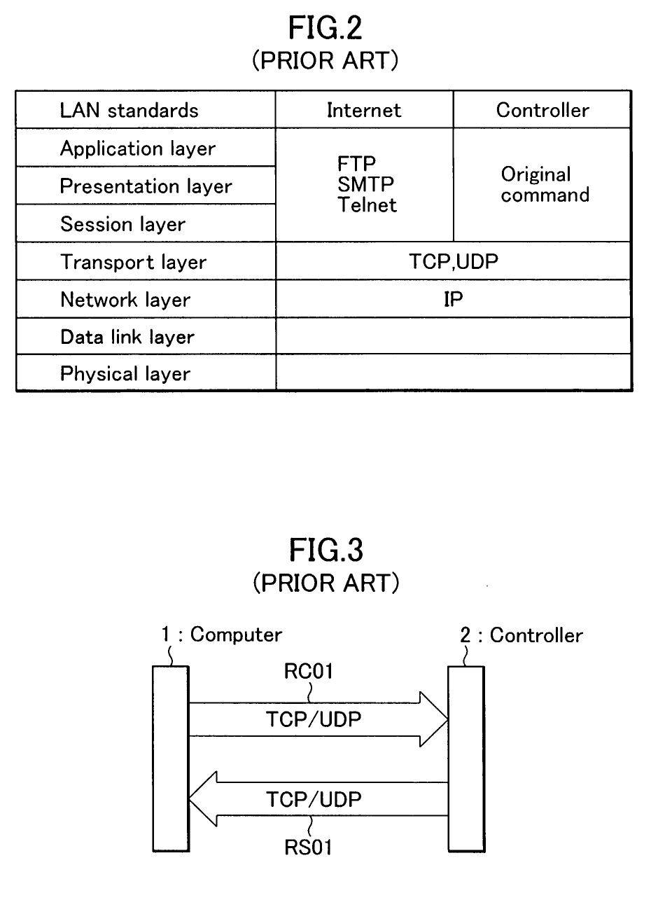

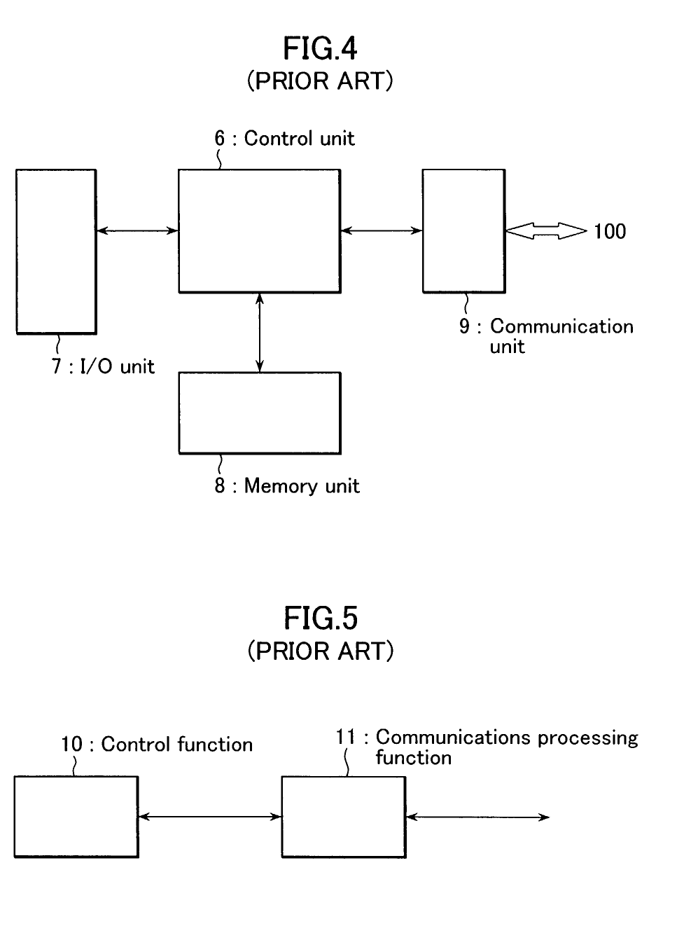

### DETAILED DESCRIPTION OF PREFERRED EMBODIMENTS

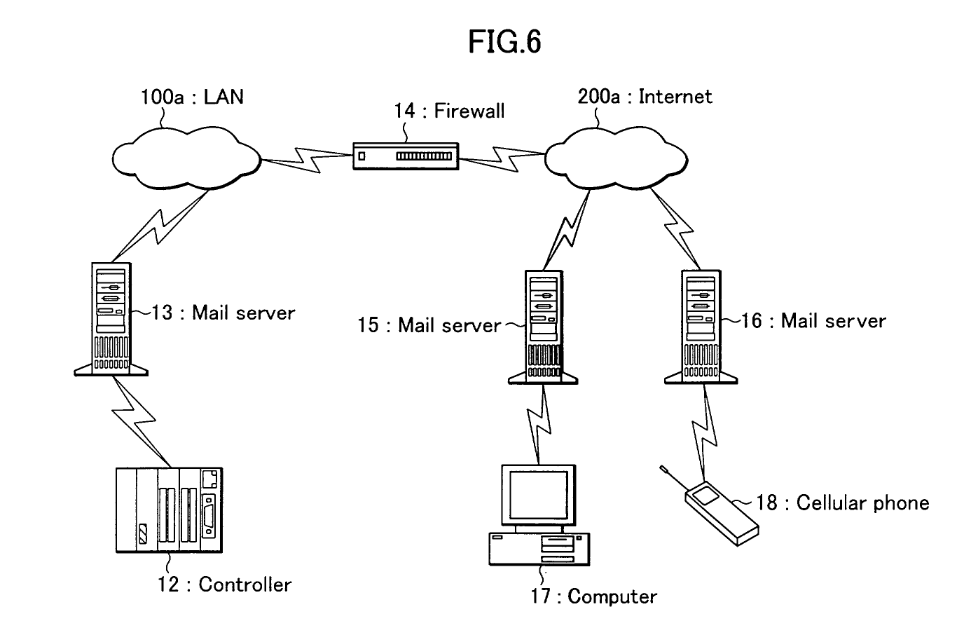

Now, the present invention is described in detail by referring to the accompanying drawings. FIG. 6 is a schematic view showing one embodiment of the remote maintenance system according to the present invention. In FIG. 6, numeral 12 denotes a controller to be maintained, numerals 13, 15 and 16 denote mail servers, numeral 14 denotes a firewall, numeral 17 denotes a computer serving as a maintenance command unit, numeral 18 denotes a cellular phone serving as a maintenance command unit capable of sending and receiving emails through the Internet, numeral 100a denotes a LAN, and numeral 200a denotes the Internet.

The controller 12 exchanges emails with the mail server 13, the mail server 13 is connected to the LAN 100a, and the LAN 100a is connected to the Internet 200a through the firewall 14.

The mail servers 15 and 16 are connected to the Internet 200a, the computer 17 exchanges emails with the mail server 15, and the cellular phone 18 exchanges emails with the mail server 16.

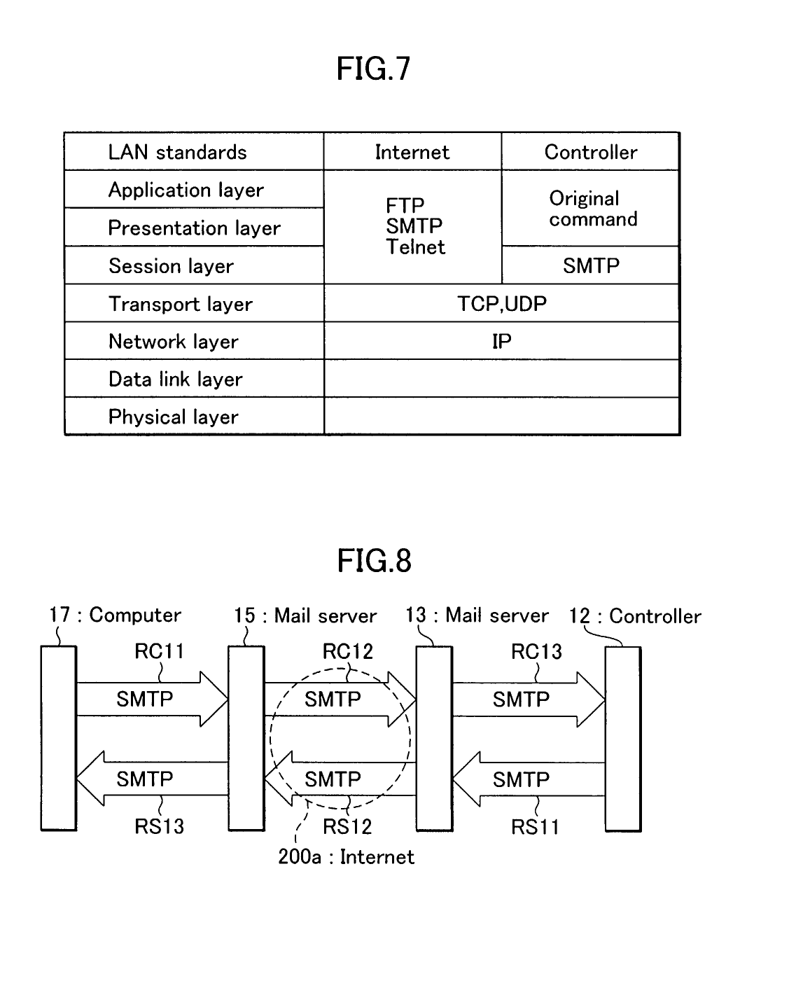

Now, the way the embodiment of FIG. 6 behaves is explained by referring to FIGS. 7 and 8. FIG. 7 is a table showing protocols, etc. that are used by the Internet and controller 12 compatible with the structural model of the seven-layer network protocol established by the ISO, and FIG. 8 is a schematic view explaining communication carried out between the computer 17 and controller 12.

When remote maintenance is performed from the computer 17 through the Internet 200a and LAN 100a on the controller 12, the computer 17 sends an email to the controller 12 using the Simple Mail Transfer Protocol (SMTP) of the session layer which is positioned above the transport layer shown in FIG. 7.

More specifically, a command is written into the text or attached file of the email and then the email is sent out.

Since the firewall 14, when configured normally, allows emails to pass therethrough, it is possible to prevent the emails from being blocked by the firewall 14.

For example, the computer 17 sends an email to the mail server 15 using SMTP, as indicated by “RC11” in FIG. 8. The mail server 15 sends the received email to the mail server 13 through the Internet 200a, firewall 14 and LAN 100a, as indicated by “RC12” in FIG. 8. Then, the controller 12 receives the email from the mail server 13, as indicated by “RC13” in FIG. 8.

The controller 12 that has received the email from mail server 13 extracts the command from the text or attached file of the email and executes it. In addition, the controller 12 sends a response to the computer 17, as necessary, using the SMTP of the session layer shown in FIG. 7.

More specifically, a response is written into the text or attached file of the email and then the email is sent out.

For example, the controller 12 sends the email to the mail server 13 using SMTP, as indicated by “RS11” in FIG. 8. The mail server 13 sends the received email to the mail server 15 through the LAN 100a, firewall 14 and Internet 200a, as indicated by “RS12” in FIG. 8. Then, the computer 17 receives the email from the mail server 15, as indicated by “RS13” in FIG. 8.

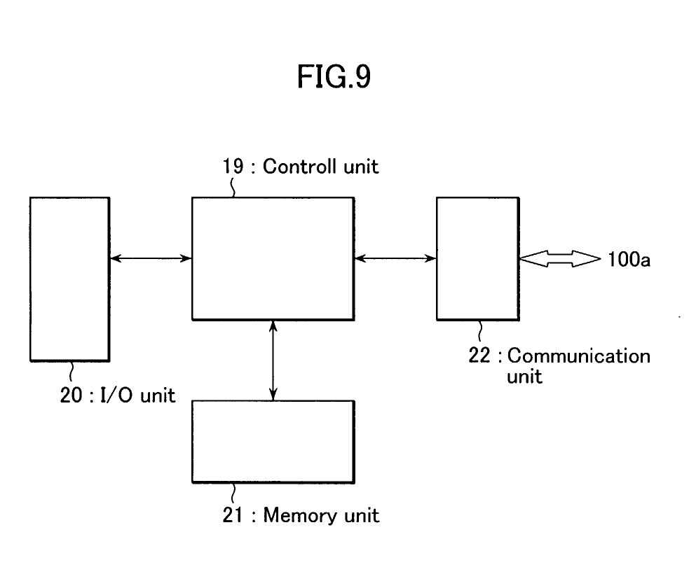

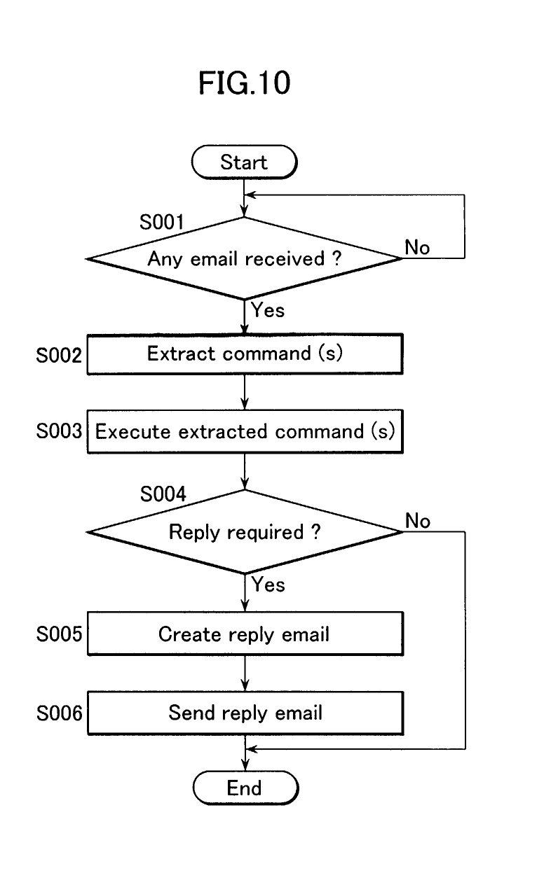

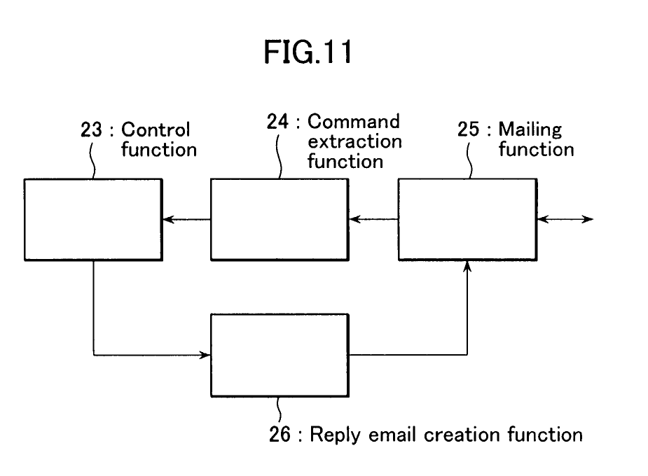

Now, the way the controller 12 behaves is described in further detail by referring to FIGS. 9, 10 and 11. FIG. 9 is a block diagram showing an example of the way the controller 12 is configured, FIG. 10 is a flowchart explaining the way the control unit of the controller 12 behaves, and FIG. 11 is a block diagram showing in detail the way the control unit of the controller 12 is configured.

In FIG. 9, a symbol 100a denotes the same element as in FIG. 6, numeral 19 denotes a control unit for controlling the controller 12 as a whole, numeral 20 denotes an I/O unit to which various inputs and outputs are connected, numeral 21 denotes a memory unit in which data, programs wherein the way the controller 12 is operated is written, and so on are stored, and numeral 22 denotes a communication unit that communicates through the LAN 100a.

The LAN 100a is connected to the communication unit 22, the input and output of which are mutually connected to the control unit 19. Likewise, the input and output of the I/O unit 20 and those of the memory unit 21 are mutually connected to control unit 19.

In step “S001” of FIG. 10, the control unit 19 receives an email arriving through the LAN 100a by way of the communication unit 22; in step “S002” of FIG. 10, the control unit 19 extracts a command from the received email; and in step “S003” of FIG. 10, the control unit 19 executes the extracted command.

In step “S004” of FIG. 10, the control unit 19 judges whether or not a response is required. If required, the control unit 19 creates a reply email in step “S005” of FIG. 10, and sends the reply email through the LAN 100a by way of communication unit 22 in step “S006” of FIG. 10.

For example, if the extracted command is a request for reading data in the controller 12, the control unit 19 reads the specified data stored in the memory unit 21 and sends the data to the LAN 100a through the communication unit 22.

The control unit 19 will now be described in further detail. In FIG. 11, numeral 23 denotes a control function, numeral 24 denotes a command extraction function for extracting commands from the text or attached files of emails, numeral 25 denotes a mailing function compliant with the SMTP communication protocol, and numeral 26 denotes a reply email creation function for writing a response into the text or attached file of an email.

An email from the communication unit 22 is received by the mailing function 25 and processed by the command extraction function 24, and the result of processing is passed to the control function 23. In addition, a response from the control function 23 is processed by the reply email creation function 26 and the result of processing is passed to the mailing function 25.

The mailing function 25 receives the email through the communication unit 22 according to SMTP, and the command extraction function 24 extracts a command from the text or attached file of the received email, and transfers the command to the control function 23.

The control function 23 executes the command and, if necessary, transfers the response to the reply email creation function 26.

The reply email creation function 26 that has received the response from the control function 23 writes the response into the text or attached file of the email and transfers the created email to the mailing function 25.

The mailing function 25 sends the received email through the communication unit 22 according to SMTP.

As a result, the need for reconfiguring the firewall, i.e., the network environment, can be eliminated by writing the command into the text or attached file of the email and sending the email to the controller 12 by using SMTP, which makes the firewall 14 passable, as the communication protocol.

Furthermore, by sending a response by email from the controller 12 as necessary, it is possible to obtain required data and verify the configuration and operating condition of the controller 12 on the computer 17 side.

Although in the illustration given in FIG. 6, only a controller is shown as the equipment to be maintained, it is also possible to remotely maintain such equipment as a measuring instrument, recorder, control equipment other than the controller, and office automation equipment capable of sending and receiving emails.

Although in the illustration given in FIG. 6, an email with a command written into the text thereof, for example, is sent from the computer 17, the email may be sent from the cellular phone 18 to the controller 12.

If capable of sending and receiving emails through the Internet, a PHS (Personal Handyphone System) phone, Personal Digital (Data) Assistant (PDA), or any other device may be used in place of the cellular phone 18.

Although in the illustration given in FIG. 8, SMTP is used for all communication, transmission-only and receiving-only mail servers may be installed separately in some cases.

For example, in such a configuration as discussed above, the receiving-only mail server may use Post Office Protocol (POP) as the communication protocol, to send the received email to a computer or the like that is a client.

In the present invention, Simple Mail Transfer Protocol (SMTP) is used to send emails to a mail server, Post Office Protocol (POP) is used to receive emails, and such a protocol as Internet Message Access Protocol (IMAP) is used to receive emails from a mail server.

As security measures, a password may be written separately into the text or attached file of an email. As a result, security is improved and it is possible to prevent any third party who does not know the password from gaining unauthorized access to the controller 12.

Since an email simply provided with a password can be intercepted by a malicious third party, the text or attached file of an email may be encrypted and transmitted, and then decrypted on the receiving side. As a result, security is improved further.

Since remote maintenance through the Internet 200a is feasible, it is also possible to remotely maintain equipment installed in an overseas location.

Since a plurality of commands can be written into the text or attached file of an email, it is possible to have a complex process executed with just one email.

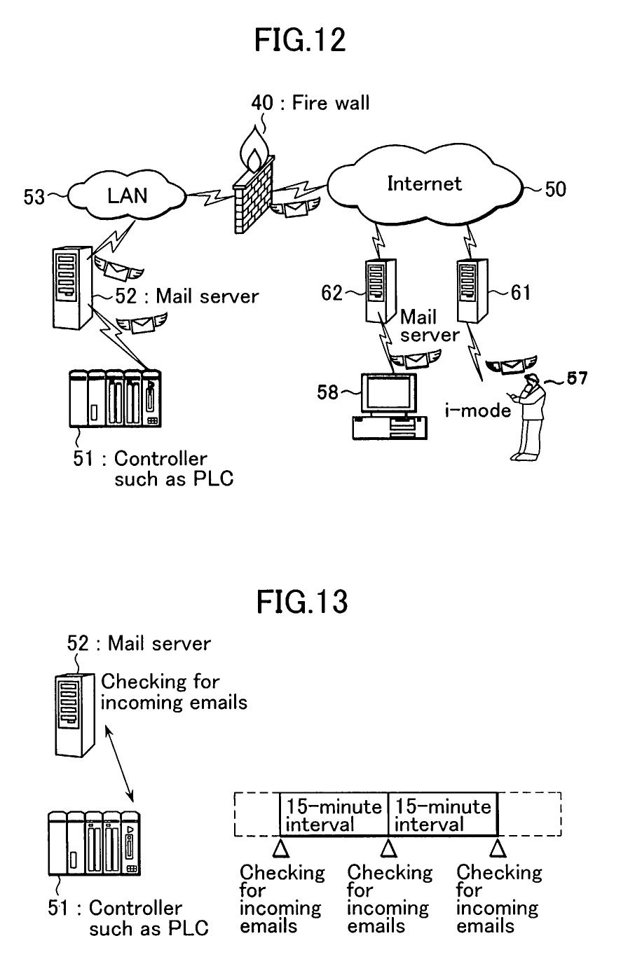

Now, FIG. 12 shows an example of system configuration for maintaining a controller, such as a programmable logic controller (PLC), from a remote place, using emails. In FIG. 12, a controller 51 is designed to be able to communicate with a mail server 52.

The mail server 52 is connected to a Local Area Network (LAN) 53, and the LAN 53 is connected to the Internet 50 through a firewall 40. The firewall 40 is a unit for preventing unauthorized access from the Internet 50.

To the Internet 50, mail servers 61 and 62 are connected. The mail server 61 relays emails from a cellular phone or PHS (Personal Handyphone System) phone 57 to the Internet 50, and the mail server 62 relays emails from a personal computer 58.

In such a system as described above, it is possible to remotely maintain the controller 51 by reading or writing data from/to the controller 51 through the cellular or PHS phone 57 or the personal computer 58 by means of email.

Now, the sequence whereby the controller 51 reads emails according to FIG. 13 is explained. Note that elements identical to those of FIG. 12 are referenced alike and excluded from the explanation. The controller 51 queries the mail server 52 at a fixed interval, in order to make sure if any email addressed to the controller itself has arrived.

Although the response of remote maintenance can be made faster by shortening the interval at which incoming emails are checked for, too short intervals will increase the load on the mail server 52 or LAN 53. In order to reduce the load on these equipment, incoming mails are checked for at a certain time interval. For example, incoming emails are checked for at a 15-minute interval, as shown to the right of FIG. 13.

Unfortunately, such an email-based remote maintenance system as heretofore described has the following problems.

The email-based remote maintenance system described above is most often used in case of emergency, such as troubleshooting. In case of troubleshooting, emails are very often used to send commands to the controller 51. However, the controller 51 can only receive emails at the interval at which it checks the mail server 52 for incoming emails. This used to result in the problem of slower response of the controller 51.

If the interval of checking for incoming emails is shortened to avoid the problem, excess load is imposed on the mail server 52 or LAN 53. This used to result in another problem that the overload prevents a controller or other equipment connected to the mail server 52 or LAN 53 from operating properly.

It is therefore desired that an email-based data processing system can be provided wherein the interval of checking the mail server for incoming emails addressed to the equipment in question itself is automatically changed in order to increase efficiency and prevent excess load from being imposed on the mail server or any other equipment.

Now, embodiments of the present invention will be described in detail according to the accompanying drawings.

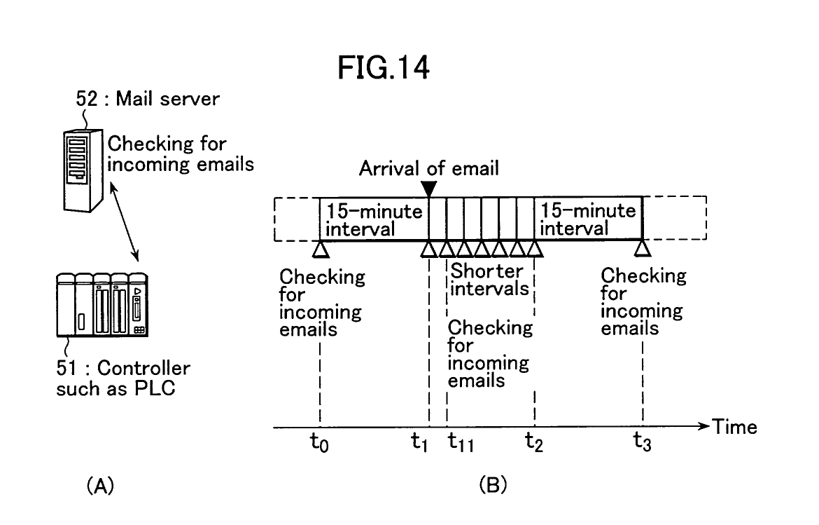

FIG. 14 is a schematic view showing one embodiment of the present invention. Note that elements identical to those of FIG. 12 are referenced alike and excluded from the explanation. FIG. 14(A) shows the relationship between the controller 51 and the mail server 52.

The controller 51 periodically checks the mail server 52 for incoming emails addressed to the controller itself and outputs emails to be sent to the mail server 52. Note that the LAN 53, firewall 40, Internet 50, mail servers 61 and 62, cellular phone or PHS phone 57, and personal computer 58 share the same configurations as those of FIG. 6, but are not shown in this figure.

FIG. 14(B) shows the timing with which the controller 51 checks the mail server 52 for incoming emails. The controller 51 checks if there is any incoming email addressed to the controller itself at an interval of, for example, 15 minutes like the example of the prior art system. Since there is no incoming email at t0, the next checking for incoming emails is performed 15 minutes later at t1.

If an incoming email is found at t1, the system moves to maintenance mode, and automatically changes the time of the next checking to t11. The difference between t11 and t1 is set to a time interval of, for example, 3 minutes which is sufficiently shorter than the predetermined time interval of 15 minutes. Hereinafter, the checking for incoming emails is performed at this shorter time interval.

Thus, incoming emails are checked for at the shorter time interval during the period from t1, when the first checking for incoming emails is performed, to t2 which is 15 minutes later than t1. When the period expires, the interval of checking for incoming emails is reset to the predetermined interval of 15 minutes and thereafter, the checking is performed at this time interval.

In other words, the interval of checking for incoming emails is shortened if any email arrives, and when a specified period expires, the interval is reset to the original setpoint. By using this method, it is possible to receive transmitted emails with a minimum delay, without imposing excess load on the mail server 2 or LAN 3.

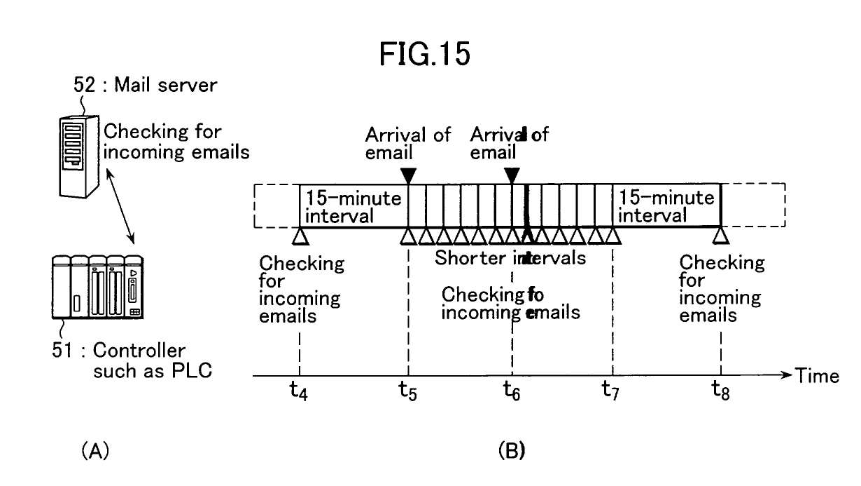

FIG. 15 shows another embodiment of the present invention. Note that elements identical to those of FIG. 14 are referenced alike and excluded from the explanation. In this embodiment, if there is another email arriving when the checking for incoming emails is performed at a shorter interval, the period during which the checking is performed at this shorter interval is prolonged automatically. FIG. 15(A) shows the relationship between the controller 51 and the mail server 52. Since FIG. 15(A) is identical to FIG. 14(A), the figure is not explained here.

In FIG. 15(B), the checking of incoming emails is performed at t4. At this moment, the interval of checking for incoming emails is set to the longer interval, i.e., 15 minutes, and therefore, no checking is performed until t5 which is 15 minutes later than t4.

When the checking for incoming emails is performed at t5, it is found that an email addressed to the controller 51 itself has arrived. Therefore, the controller is automatically reconfigured so that hereinafter, the checking for incoming emails is performed at a shorter interval (3 minutes, for example). As a result, it is found that another email has arrived at t6 which is later than t5 but before a time lapse of 15 minutes.

In the embodiment of FIG. 14, if the period during which the checking for incoming emails is performed at a shorter interval reaches the longer interval (15 minutes) of checking for incoming emails, the interval setpoint is automatically changed to the longer interval. In this embodiment however, if another email arrives when incoming emails are being checked for at the shorter interval, the return to the mode of checking for incoming emails at the longer interval is reset and the period during which incoming emails are checked for at the shorter interval is prolonged.

Since the arrival of another email is recognized at t6, the period during which incoming emails are checked for at the shorter interval is prolonged by another 15 minutes, so that the shorter-interval checking is performed until t7. Also, since no further email has arrived during the period from t6 to t7, the interval setpoint is automatically changed to the longer interval at t7. Thus, the next checking for incoming emails is performed at t8 which is 15 minutes later than t7.

In this method, the period during which incoming emails are checked for at a shorter interval is prolonged when new emails arrive in succession. When new emails no longer arrive, the interval setpoint is automatically changed to a longer interval. As a result, it is possible to receive emails with a minimum delay even when new emails keep arriving for a prolonged period of time, without imposing excess load on the LAN 53 or mail server 52.

Note that in this embodiment, it is also possible to read data from and write data to the controller 51, read, write and modify programs stored in the controller 51, read logging information within the controller 51, and change various settings and operating mode of the controller 51.

In these embodiments, a controller is maintained using emails. However, these embodiments are also applicable to other types of equipment, such as distributed control systems (DCS), measuring instruments, control equipment, and office automation (OA) equipment.

It is also possible to apply these embodiments to monitoring systems that utilize emails. The embodiments are considered to be extremely effective when applied to a monitoring system, since access to the system using emails may increase in case any failure is detected.

As is evident from the description heretofore given, the following advantages are provided according to the present invention:

According to the present invention, it is possible to eliminate the need for reconfiguring a firewall, i.e., network environment, by using SMTP, which makes the firewall passable, as the communication protocol, writing a command into the text or attached file of an email, and then sending the email to target equipment.

According to the present invention, it is also possible to obtain required information and verify the target equipment's configuration and operating condition on the command unit side, by sending responses from the equipment as necessary, using emails.

According to the present invention, it is also possible to improve security by separately writing a password into the text or attached file of an email or by encrypting the text or attached file of the email before sending the email.

According to the present invention, it is also possible to have a complex process executed with just one email by writing a plurality of commands into the text or attached file of an email.

Also according to the present invention, there is provided an email-based data processing system, comprising a data processing unit and a mail server connected to the data processing unit, wherein the data processing unit receives emails addressed to the unit itself, by querying the mail server at a specified interval, in order to make sure if any email addressed to the unit itself has arrived. The system is configured so that if the data processing unit recognizes the arrival of any email addressed to the unit itself, the interval of checking the mail server for incoming emails is changed to a first interval, which is shorter than the specified interval, for a given period of time.

As a result, it is possible to reliably receive emails with a minimum delay even when emails arrive frequently during maintenance, for example. This system configuration provides the advantage that faster response is achieved and data is processed in an efficient manner. Another advantage is that no excess load is imposed on the mail server or LAN since incoming emails are checked for at a longer interval under normal conditions.

Also according to the present invention, the data processing unit is designed so that if it detects the arrival of any email addressed to the unit itself when checking the mail server for incoming emails at a first interval, the unit prolongs the period of checking for incoming emails at the first interval for a given period of time.

As a result, the system provides the advantage that the data processing unit can reliably receive emails with a minimum delay even if the period during which emails arrive at a higher frequency is prolonged. Another advantage is that no excess load is imposed on the mail server or LAN since incoming emails are checked for at a longer interval under normal conditions.

Also according to the present invention, the system comprises a controller for controlling a process or the like as the data processing unit. As a result, the system provides the advantage that reliability is increased since remote maintenance can be achieved easily.

Also according to the present invention, a characteristic of the system is that the controller is capable of at least one function among writing and reading data using emails, reading, writing and modifying programs, reading logging information, and changing various settings and operating mode.

As a result, the system provides the advantage that maintenance can be performed promptly since it is possible to view and modify programs and data and change various settings using emails.

Also according to the present invention, the system can comprise a monitoring system as the data processing unit 51. As a result, the system provides the advantage that queries can be processed efficiently even when they drastically increase in number, as often happens with the monitoring system when a failure is detected.

Also according to the present invention, the system is characteristic in that the mail server 52 is connected to the Internet 50. As a result, the system provides the advantage that maintenance can be performed easily from any location, since the mail server 52 is accessible through the Internet from anywhere in the world.

Also according to the present invention, a characteristic of the system is that a firewall is located between the mail server and the Internet. As a result, the system provides the advantage that unauthorized access is prevented.

Also according to the present invention, a characteristic of the system is that emails are sent to the mail server from a cellular phone or PHS phone connected to the Internet. As a result, the system provides the advantage that access to the data processing unit is possible from any location.

Furthermore, the present invention provides the following advantages over the invention described in the U.S. Pat. U.S. Pat. No. 6,282,454 herein cited as an example of the prior art system.

The module presented by U.S. Pat. No. 6,282,454 serves as a web site, while the system of the present invention has no web site functions but has an email-based mailing function (mail-client function). This means that the module presented by U.S. Pat. No. 6,282,454 involves setting a global IP address when the module needs to be accessed through the Internet. The present invention, on the other hand, does not necessarily require the IP address to be global since an email server exists between the Internet and the module in accordance with the present invention. Thus, it is possible to set either a global IP address or a local IP address, whichever is preferred.

The module presented by U.S. Pat. No. 6,282,454 is designed to send back a response for a request from a browser or application software having a browser function. On the other hand, the system of the present invention is configured so that a response is sent back using an email, for an email-based request from an email mailer (mail client) or application software having a mailer function.

The module presented by U.S. Pat. No. 6,282,454 has a web server function. On the other hand, the system of the present invention has a mail server located between the mailer for sending requests and the module provided herein according to the present invention for exchange of emails. The aforementioned module itself does not have any mail server function. Therefore, besides there being a difference between the two inventions as to whether a web server or a mail server is used, the module of the present invention need not have any server function.

The module presented by U.S. Pat. No. 6,282,454 uses Hypertext Transport Protocol (HTTP) as the protocol for sending and receiving commands/responses to and from application software having a browser or a browser function. In contrast, the module of the present invention uses the protocol known as Simple Mail Transfer Protocol (SMTP) in order to send emails to a mail server, as well as a protocol, such as Post Office Protocol (POP) or Internet Message Access Protocol (IMAP), in order to receive emails from a mail server.

To be able to monitor device information on a PLC through a browser by using the module presented by U.S. Pat. No. 6,282,454, a hypertext document (pages) for monitoring required devices must be made previously available and then stored in the module. As a result, it is difficult to change a device to be monitored when this type of module is used. On the other hand, according to the present invention, it is possible to monitor all of the devices within the PLC or rewrite a list of devices to be monitored, by changing the device or devices specified by a command contained in an email transmitted from a mailer (mail client). This means that it is not necessary to previously determine the devices to be monitored.

What is claimed is:

1. A remote maintenance system for remotely configuring and maintaining target equipment, comprising:
said target equipment to be remotely maintained; and
a command unit for sending an email containing a command to said target equipment through the Internet, wherein said target equipment executes said command contained in said email received by said target equipment, so that said target equipment is configured and maintained.

2. The remote maintenance system of claim 1, wherein said target equipment sends an email containing a response to said command unit through the Internet, as necessary.

3. The remote maintenance system of claim 1, wherein said command is written into the text or attached file of an email.

4. The remote maintenance system of claim 2, wherein said response is written into the text or attached file of an email.

5. The remote maintenance system of claim 3 or 4, wherein a password is written into the text or attached file of an email.

6. The remote maintenance system of claim 3 or 4, wherein the text or attached file of an email is encrypted before transmission.

7. The remote maintenance system of claim 3, wherein a plurality of commands, instead of said command, are written into the text or attached file of an email.

8. The remote maintenance system of claim 1 or 2, wherein said target equipment is a controller capable of sending and receiving emails.

9. The remote maintenance system of claim 1 or 2, wherein said target equipment is a measuring instrument capable of sending and receiving emails.

10. The remote maintenance system of claim 1 or 2, wherein said target equipment is a recorder capable of sending and receiving emails.

11. The remote maintenance system of claim 1 or 2, wherein said target equipment is office automation equipment capable of sending and receiving emails.

12. The remote maintenance system of claim 1 or 2, wherein said target equipment is control equipment capable of sending and receiving emails.

13. The remote maintenance system of claim 1, wherein said command unit is a computer capable of sending and receiving emails.

14. The remote maintenance system of claim 13, wherein when sending emails, said command unit uses such a protocol for receiving emails from a mail server as the Simple Mail Transfer Protocol (SMTP), Post Office Protocol (POP) and Internet Message Access Protocol (IMAP) of the session layer positioned above the transport layer.

15. The remote maintenance system of claim 1, wherein said command unit is a cellular phone capable of sending and receiving emails.

16. The remote maintenance system of claim 1, wherein said command unit is a PHS phone capable of sending and receiving emails.

17. The remote maintenance system of claim 1, wherein said command unit is a PDA capable of sending and receiving emails.

18. An email-based data processing system, comprising:
a data processing unit; and
a mail server connected to said data processing unit, wherein said data processing unit performs checking for incoming emails at a specified interval by querying said mail server for arrival of any email addressed to said data processing unit itself.

19. The email-based data processing system of claim 18, wherein once said data processing unit confirms the arrival of any email addressed to said data processing unit itself, the interval of checking said mail server for incoming emails is changed for a given period, to a first interval shorter than said specified interval.

20. The email-based data processing system of claim 18 or 19, wherein if said data processing unit detects the arrival of any email addressed to said data processing unit itself while checking said mail server for incoming emails at said first interval, the period during which incoming emails are checked for at said first interval is prolonged for a given period.

21. The email-based data processing system of claim 18, 19 or 20, wherein said data processing unit is a controller.

22. The email-based data processing system of claim 21, wherein said controller is capable of at least one function among writing and reading data using emails, reading, writing and modifying programs, reading logging information, and changing various data items and the operating mode.

23. The email-based data processing system of claim 18, 19 or 20, wherein said data processing unit is a monitoring system.

24. The email-based data processing system of claim 18, 19, 20, 21, 22 or 23, wherein said mail server is connected to the Internet.

25. The email-based data processing system of claim 24, wherein a firewall is located between said mail server and the Internet.

26. The email-based data processing system of claim 24 or 25, wherein emails are sent to said mail server from a cellular phone or PHS phone connected to the Internet.
